(19) United States
(12) Patent Application Publication
(10) Pub. No.: US 2026/0160400 A1
(43) Pub. Date: Jun. 11, 2026

(54) LIGHTING DEVICE FOR VEHICLES AND METHOD OF MANUFACTURE

(71) Applicant: HELLA GMBH & CO. KGAA, Lippstadt (DE)

(72) Inventor: Paul Friesen, Rheda-Wiedenbrück (DE)

(21) Appl. No.: 19/414,571

(22) Filed: Dec. 10, 2025

(30) Foreign Application Priority Data
Dec. 10, 2024 (DE) 102024136834.9

(51) Int. Cl. F21S 43/20; F21S 43/14; F21S 43/27; F21S 43/50; F21Y 115/10

(52) U.S. Cl. CPC F21S 43/2641; F21S 43/14; F21S 43/2643; F21S 43/27; F21S 43/28131; F21S 43/28135; F21S 43/51; F21S 2243/00; F21Y 2115/10

(57) ABSTRACT

The invention relates to a lighting device for vehicles including a carrier layer on which a plurality of light sources are arranged in a matrix-like manner, and an optical film having a plurality of optical elements arranged in a matrix-like manner, each assigned to the light sources. The optical film is designed such that the optical elements are formed as raised bulges from a base surface of the optical film.

### CROSS-REFERENCE TO RELATED APPLICATIONS

The present application claims the benefit of German Patent Application 10-2024-136-834.9, filed Dec. 10, 2024, the disclosure of which is incorporated by reference.

### FIELD OF THE INVENTION

The invention relates to a lighting device for vehicles having a carrier layer on which a plurality of light sources are arranged in a matrix-like manner, an optical film having a plurality of optical elements arranged in a matrix-like manner and assigned to the respective light sources. The invention also relates to a method of manufacturing the lighting device.

### BACKGROUND OF THE INVENTION

From DE 10-2011-012-789 A1, an interior trim part for a vehicle is known which has a film that is placed on a metal layer with an opening and is adapted to the shape of the metal layer by thermoforming, whereby a bulge of the film is formed in an opening of the metal layer. On a side opposite the metal layer, the film is back-molded with a carrier layer. A disadvantage of this is that defects can occur when the film is back-molded, making it difficult to use the film for lighting devices.

A lighting device for vehicles is known from EP 4116760 A1, which can be used as a large-area light display in a front or rear area of a vehicle in order to interact with other road users by displaying lettering, symbols, etc. Such light displays can extend across the full width of a vehicle, so that a relatively large area can be covered for the display of such graphic information. The lighting device is designed as a film with three layers. On the one hand, it has a carrier layer on which a large number of light sources arranged in a matrix-like manner are arranged as a light source array. A transparent lens adjoins the light source side. On one side of the lens facing away from the carrier layer, a microlens array with a plurality of microlenses, each assigned to a specific light source, adjoins the optical layer. The bulbously shaped microlenses serve as optical elements that deflect the light that hits them. A disadvantage of the known lighting device is that its manufacture is relatively complex and expensive.

### SUMMARY OF THE INVENTION

The object of the present invention is therefore to provide a lighting device for vehicles and a method for manufacturing the lighting device in such a way that relatively thin and large-area lighting is ensured in a simple and inexpensive manner.

To achieve this object, the invention in conjunction with the current embodiments is characterized in that the optical film is designed such that the optical elements are formed as raised bulges from a base surface of the optical film.

The particular advantage of the lighting device according to one embodiment of the invention is that by providing raised bulges, an optical film can be produced in a simple and effective manner, which serves to deflect light. The bulges are formed by reshaping a film so that it only has the optical effect after the film has been reshaped. The bulges are formed by reshaping a film, wherein, depending on the location of use on a body or depending on an arrangement of a base surface of the film in which the light sources extend that is inclined to a vertical plane, the light can be deflected in the main emission direction of the lighting device. Thus, regardless of the angular position of the film or the plane of the light sources, the light is aligned with the main emission direction of the lighting device. The film can, for example, consist of an opaque and/or diffuse material.

According to a preferred embodiment of the invention, the bulges are each hat-shaped with a cover surface and upright surfaces extending from the edge of the cover surface to a base surface of the optical film. The bulges thus preferably have the same wall thickness as a base surface of the optical film, with the base surface of the optical film extending in one plane and connecting the bulges. The bulges in the optical film can be formed by deep drawing, for example, which increases the inherent stability of the film. Like the light sources, the bulges are arranged in a pixel-like distribution, with one bulge assigned to each light source. Depending on a predetermined viewing angle requirement or refraction angle, the bulges can each have a corresponding orientation of the cover surface. The cover surface serves to refract the light entering the bulge. The angle of the upright surfaces is relatively small in relation to the direction of emission of the light emitted by the respective light sources, so that no optical effect is achieved.

According to a further embodiment of the invention, the optical film is connected to an opaque decorative frame on a front side having the bulges, which has openings for receiving the bulges. This provides a clear optical demarcation between the individual luminous areas formed by the cover surfaces of the bulges. The decorative frame increases the thermal stability of the bulges. In addition, it provides optical shielding from adjacent bulges, so that no unwanted light pixels appear at adjacent bulges. Advantageously, sharply defined symbols can be displayed, each formed from a plurality of switched-on light sources (light pixels).

According to a further embodiment of the invention, a wall thickness of the decorative frame is smaller than a height of the bulges. This ensures that the cover surface of the bulges is exposed and that the light can radiate unhindered.

According to a further embodiment of the invention, a damping layer with a plurality of apertures which are arranged in alignment with the light sources is arranged between the light source array or the carrier layer and the optical film. The damping layer protects the light sources during the installation of the film composite. Additionally, the damping layer dampens vibrations during operation of the lighting system in the vehicle. Additionally, it has a damping effect when a component formed by the optical film and the decorative frame expands thermally.

According to a further embodiment of the invention, the damping layer consists of a flexible material. In particular, the material of the damping layer is more elastic than the optical film and/or the carrier layer. For example, the damping layer can be made of thermoplastic polyurethane (TPU), thermoplastic elastomer (TPE), or silicone.

According to a further embodiment of the invention, at least two optical films are arranged between the damping layer and the carrier layer, each of which has bulges of different geometric shape. Advantageously, a homogenization of the light can be achieved by the additional at least second optical film.

According to a further embodiment of the invention, a plurality of film composites are provided, each formed from an optical film and a decorative frame, each with differently shaped bulges, which are arranged next to one another on a carrier layer covered by a damping layer and bonded to the latter. In this way, different visual effects can be achieved across the surface. Thus, a first film composite can have such first bulges that the first film composite can be arranged in a vertical body area of the vehicle and generates the corresponding predetermined signal light function or light signature. A second film composite adjoining the first film composite can have such second bulges that the second film composite can be arranged in the body area at an angle to a vertical plane and at an angle of inclination to a vertical plane. The second film composite can thus extend to an area adjacent to a hood in the front area, while in the rear area it can be arranged in an area of the body adjacent to the trunk lid. Advantageously, the light can be adapted to the shape of the body, ensuring that the emitted light corresponds to the predetermined light signature. This allows for optimal viewing angle stability.

According to a further embodiment of the invention, the decorative frame has greater rigidity than the optical film. Advantageously, this facilitates installation if the film composite consisting of the decorative frame and the optical film is assembled using a sandwich process with the carrier layer and the damping layer, with the light sources and the bulges being arranged in alignment.

In order to achieve this object, the invention has the features of the current embodiments.

The particular advantage of the method according to an embodiment of the invention is that an optical effect can be easily created by thermally forming a film. The result is a pre-embossed or pre-formed optical film, with the optical effect being created by the formed bulges. The quasi-deep-drawing of the film increases the inherent stability of the optical film. The thermal stability is increased by the materially bonded connection to a decorative frame, which exposes the bulges with its openings. In addition, the decorative frame has a shielding effect against adjacent bulges. It prevents stray light from reaching adjacent bulges, which would otherwise lead to unwanted illumination of those bulges without the corresponding adjacent bulge being illuminated by that assigned light source.

According to a further embodiment of the invention, a damping layer is placed on the carrier layer provided with the light sources, which has corresponding apertures in alignment with the light sources. Subsequently, a force-fit connection is made between the carrier layer and damping layer, which only lie flat against one another, with the primary optical composite, so that a large-area lighting device is created in the manner of a light display, with the optical effect being achieved by preformed bulges. The optical effect is achieved by refraction. The bulges have no lens effect, as the cover surface and the bulge each have a constant wall thickness.

According to a further embodiment of the invention, a plurality of primary optical composites with differently shaped bulges are provided, so that the lighting device can be attached to curved body areas or body areas with different extension planes. The bulges of the respective primary optical composites have the same shape, i.e. one primary optical composite has bulges of a first shape and a second primary optical composite has bulges of a second shape. By placing the different primary optical composites butt-to-butt after they have been placed on a damping layer, a lighting device can be created by subsequently connecting the plurality of primary optical composites to the damping layer and to the carrier layer in a force-fitting manner, which deflects the light in different directions depending on the primary optical composites. This allows for the advantageous creation of a relatively large light signature that is independent of the shape of the body on which it is mounted.

Further advantages arise from the other features of the current embodiments.

### BRIEF DESCRIPTION OF THE DRAWINGS

Exemplary embodiments of the invention are explained in more detail in the figures below. In the figures:

FIG. 1 is a side view of a lighting device attached to the front area of a body of a vehicle;

FIG. 2 is a detail X1 according to FIG. 1;

FIG. 3 is a detail X2 according to FIG. 1;

FIG. 4 is an exploded view of a primary optical composite, which is connected to a carrier layer equipped with light sources and a damping layer arranged thereon; and

FIG. 5 is a partial side view of the lighting device with two integrated optical films.

### DETAILED DESCRIPTION OF THE CURRENT EMBODIMENTS

A lighting device 1 is flat, flexible and has a large surface area and can, for example, be attached to the front of a body 2 of a motor vehicle 3 to generate an intended signal light distribution and/or light signature, such as lettering or a logo. The lettering can be the word “Hello”, for example, in order to interact with another road user. For example, the lighting device 1 can display or indicate a light signature shown as a running bar, so that a pedestrian standing at a crosswalk is signaled that the vehicle driver or the self-driving vehicle has recognized that the pedestrian wants to use the crosswalk and cross the road. The lighting device 1 can extend from a first lateral end, at which a first signal light for generating a cornering light is located, to an opposite end, at which a second signal light for the cornering light function is located. The lighting device 1 can therefore extend continuously from a right-hand side to a left-hand side of the front section of the body 2.

According to an alternative embodiment of the invention not shown, the lighting device 1 can also have a rear area for generating corresponding signal light functions, for example brake light, tail light, cornering light and light signatures for interacting with other road users.

The lighting device 1 is of multi-layer design and consists of a plurality of films lying flat against one another.

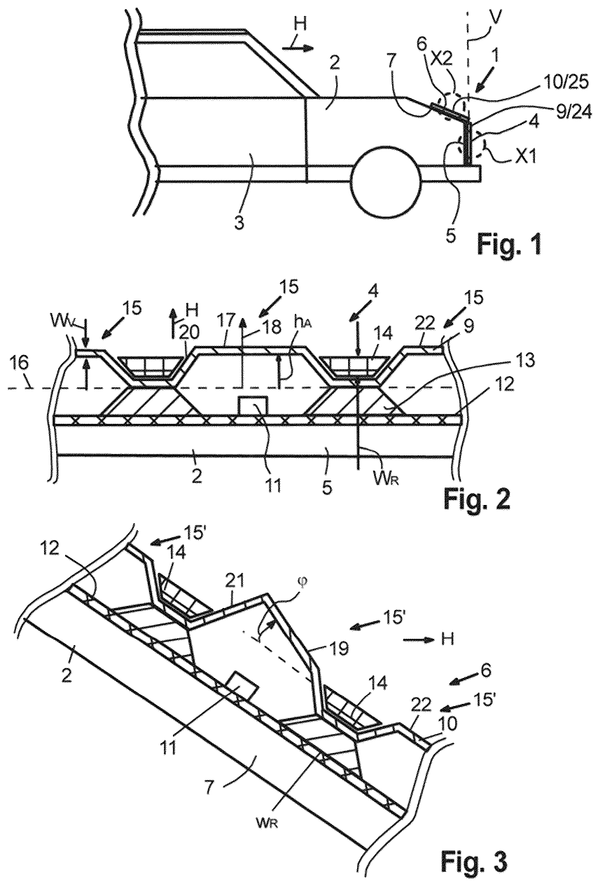

As can be seen from FIG. 1, the lighting device 1 has a first section 4, which is attached to a vertically extending body area 5. A second section 6 of the lighting device 1 is attached to a further body area 7, which runs at an angle to a vertical plane V and extends, for example, to an area where an edge of an openable hood is located. The lighting device 1 shown in FIG. 1 is designed in one piece. However, it has differently designed optical films 9, 10, which are described in more detail below.

FIGS. 2 and 3 show that the lighting device 1 preferably consists of a plurality of layers and/or films, namely a carrier film 12 (flexible printed circuit board) equipped with a plurality of light sources 11 arranged in a matrix-like manner and forming a light source array, a damping layer 13, an optical film 9, 10 and a decorative frame 14.

The carrier film 12 can alternatively be designed as a rigid printed circuit board to form a carrier layer. The decorative frame 14 can be made of an opaque polycarbonate (PC) material. The damping layer 13 serves as a buffer layer and consists of a soft component.

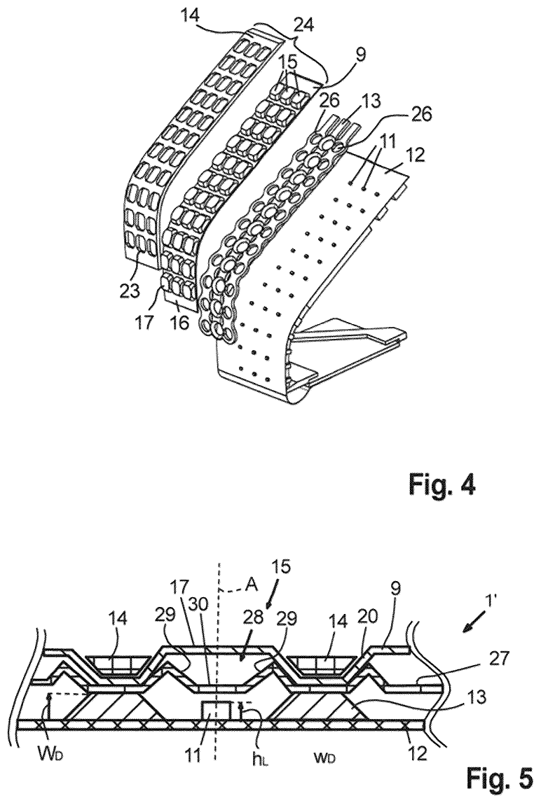

As can be seen more clearly from FIG. 4, the optical film 9, 10 has a plurality of matrix-like bulges 15 as optical elements, each of which is assigned to the light sources 11 and which extend raised from base surface 16 of the optical film 9, 10. The base surface 16 of the optical film 9, 10 extends in the direction of extension of the optical film 9, 10 and also extends flatly on a flat base. The aforementioned films 9, 10, 12, 13, 14 are flexible in design.

The bulges 15, 15′ of the optical film 9, 10 are preferably produced by thermoforming, with the flat optical film 9, 10 being formed at the respective points, for example with compressed air, from the plane of the base surface 16. The bulges 15, 15′ are hat-shaped and each have a cover surface connecting to the base surface 16.

FIG. 2 shows the first bulges 15, each of which has a cover surface 17 running parallel to the base surface 16. The light 18 emitted by the light sources 11 is thus slightly refracted by the respective cover surfaces 17, so that a light signature generated by appropriate control of the light sources 11 is clearly visible to a road user in front of the vehicle 3.

The bulges 15′ of the second section 6 shown in FIG. 3 are of trapezoidal design with an inclined cover surface 19, which forms an angle α to the base surface 16 of the optical film 10. The cover surface 19 is thus designed in such a way that the light 18 emitted onto it by the light sources 11 is refracted by the angle of inclination α of the inclined body section 7 so that it is visible to a road user in the main emission direction H for signaling the light signature.

By shaping the cover surfaces 17, 19 of the corresponding optical films 9, 10, a relatively large-area light signature can be created regardless of the shape of the body of vehicle 3. The lighting device 1 can be attached in different spatial positions in different areas of the body in a single step, as the lighting device 1 is designed in one piece.

The light shaping is preferably effected by refraction of the light 18, with the refraction being effected exclusively by the cover surface 17, 19. An upright surface 20 of the first optical film 9 and an upright surface 21 of the second optical film 10 serve to ensure that the cover surface 17 can be inclined and extends at a distance from the respective light sources 11. In addition, the upright surface 20, 21 can form a stop for the decorative frame 14.

Since the bulges 15, 15′ are formed by deformation of the optical film 9, the bulges 15, 15′ have the same wall thickness w_{O} as the base surface 16 of the optical film 9, 10 itself.

The first optical film 9 has a plurality of bulges 15, all of which are of identical design. The second optical film 10 has a plurality of bulges 15′, all of which are of identical design.

According to an alternative embodiment of the invention not shown, a film material can be used when the second section 6 is arranged at an acute angle φ (angle of inclination) to a vertical plane V, so that the light is deflected in the main emission direction H not due to the shape of the film 10, but due to its material properties. This has the advantage of reducing the elevation of the otherwise protruding upright surface 21. For example, the relatively flat section 6 of the lighting device can have the same bulges 15 as the first section 4. So if a beam of light hits the optical film vertically, for example on a cover surface of the optical film, it does not pass through the optical film in a straight line, but is deflected within the optical film by the predetermined angle of inclination φ. Although an extension surface of the light sources runs parallel to the optical film or a cover surface thereof, the light emitted by the light source is deflected by the angle of inclination φ.

After the bulges 15, 15′ on the optical film 9 have been produced in a first step by thermoforming (thermal forming), the decorative frame 14 provided with openings 23 is placed on a front side 22 of the optical film 9, 10 having the bulges 15, 15′ and materially bonded to the optical film 9, 10. For example, the decorative frame 14 can be connected to the optical film 9, 10 by laser, with the laser connection points being made on the base surface 16 of the optical film 9, 10 and on the decorative frame 14. During installation, the decorative frame 14 is placed on the optical film 9, 10 in such a way that the bulges 15 or 15′ of the optical film 9 or 10 pass through the openings 23 of the decorative frame 14. In the installation position, the decorative frame 14 abuts directly against the base surface 16 of the optical film 9, 10. Subsequently, the two layers can be materially bonded, so that now a primary optical composite 24 or 25 is formed. The first primary optical composite 24 has the first optics film 9 with the bulges 15 and the second primary optical composite 25 has the second optics film 10 with the bulges 15′. The decorative frames 14 of the first primary optical composite 24 and the second primary optical composite 25 have the same design.

In contrast to the optical film 9, 10, the decorative frame 14 is designed to be opaque, for example the decorative frame 14 is black or dark in color. The optical film 9, 10 is designed to be translucent and preferably opaque.

Preferably, a circumferential edge of the openings 23 of the decorative frame 14 abuts directly against the respective upright surfaces 20, 21 of the bulges 15, 15′. This prevents unwanted shading of light pixels (light sources) represented by the bulges 15, 15′ in adjacent areas.

The decorative frame 14 has a wall thickness w_{R} that is smaller than a height h_{A} of the bulges 15, 15′. This ensures that any refracted light can radiate unhindered from the cover surface 17, 19 of the bulges 15, 15′.

The decorative frame 14 has a greater rigidity than the optical film 9, 10. After connecting the optical film 9, 10 with the decorative frame 14 to form the primary optical composite 24, 25, said primary optical composite exhibits increased stability, which facilitates further processing to form the lighting device 1.

As can be seen from FIG. 4, the damping layer 13 has a plurality of apertures 26, which are arranged in alignment with the light sources 11, which are preferably designed as LED light sources (LED chips). A wall thickness w_{D} is preferably greater than a height h_{L} of the light sources 11. The damping layer 13 is made of a flexible material such as TPU, TPE or silicone. The elasticity of the damping layer 13 is greater than that of the carrier layer 12 and/or the decorative frame 14 and/or the optical film 9, 10. As a result, the damping layer 13 has a damping effect during operation of the lighting device and provides protection against unwanted contact with the primary optical composite 24, 25 when the lighting device 1 is installed.

To manufacture the lighting device 1, the damping layer 13 is placed on the side of the carrier layer 12 with the light sources 11, with the apertures 26 being arranged in alignment with the light sources 11. In the next step, the first primary optical composite 24 and the second primary optical composite 25 are placed butt-to-butt on the damping layer 13 with the same edges and then connected to the damping layer 13 and the carrier layer 12 in a force-fitting manner. The connection can be made using the sandwich method, either by latching or screwing.

Since the decorative frames 14 and the base surface 16 of the two optical films 9, 10 are of the same design or thickness, the two optical composites 24, 25 can be placed flush on the damping layer 13. The edges of the primary optical composites 24, 25 facing one another, abut directly against one another and can be firmly bonded together in the final manufacturing step.

The damping layer 13 can consist of an opaque material, as it has no optical effect.

According to an alternative embodiment as shown in FIG. 5, a lighting device 1′ can be provided which, in contrast to the lighting device 1, has an additional optical film 27. For example, the second optical film 27 can be placed between the damping layer 13 and the corresponding primary optical composite 24 or 25 during manufacture of the lighting device 1′, so that an additional or modified optical effect can be achieved. Compared to the bulges 15, 15′ of the first optical film 9, 10, the further or second optical film 27 has bulges 28 with upright surfaces 29 which have a lower height than the upright surfaces 20, 21 of the bulges 15, 15′. In this way, a cover surface 30 of the bulge 28 can be arranged between the respective light sources 11 and the cover surface 17, 19 of the primary optical composite 24 or 25. While the cover surfaces 17, 19 of the bulges 15, 15′ are essentially flat, the cover surface 30 of the bulges 28 is plate-shaped. The cover surface 30 therefore has a different geometric shape to the cover surfaces 17, 19 and, in combination with the two cover surfaces, results in a different light shaping. The cover surface 30 can be used, for example, to homogenize the light. Optionally, this can also increase the deflection of light from an axial direction A of the light sources 11.

The further optical film 27 can be bonded together with the first optical film 9, 10 in a sandwich process, preferably simultaneously creating a connection with the decorative frame 14 to form the primary optical composite 24.

According to a further alternative embodiment not shown, more than two optical films can also be arranged on top of one another.

### LIST OF REFERENCE SYMBOLS

1,1′ lighting device
2 body
3 vehicle
4 1st section
5 body area
6 2nd body area
7 body area
8 hood
9 optical film
10 optical film
11 light sources
12 carrier layer
13 damping layer
14 decorative frame
15,15′ bulges
16 base surface
17 cover surface
18 light
19 cover surface
20 upright surface
21 upright surface
22 front site
23 openings
24 1st primary optical composite
25 2nd primary optical composite
26 apertures
27 optical film
28 bulges
29 upright surfaces
30 cover surface
A axis direction
V vertical level
φ tilt angle
H main radiation direction
w_{O},w_{R},w_{D} wall thickness
h_{A},h_{L} height

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for vehicles, comprising:
a carrier layer on which a plurality of light sources are arranged in a matrix-like manner; and
an optical film comprising a plurality of optical elements arranged in a matrix-like manner and assigned to the respective light sources, wherein the optical elements are formed from a base surface of the optical film in the form of raised bulges.

2. The lighting device according to claim 1, wherein the bulges are each formed in the shape of a hat with a cover surface and an upright surface extending from an edge from the cover surface to the base surface of the optical film.

3. The lighting device according to claim 1, wherein the base surface and the bulges of the optical film have the same wall thickness.

4. The lighting device according to claim 1, wherein the optical film is connected on a front side having the bulges to an opaque decorative frame, which has openings for receiving the bulges to form a primary optical composite.

5. The lighting device according to claim 4, wherein a circumferential edge of the openings of the decorative frame covers the base surface of the optical film or abuts directly against the respective upright surface.

6. The lighting device according to claim 4, wherein a wall thickness of the decorative frame is smaller than a height of the bulges.

7. The lighting device according to claim 1, wherein a damping layer is arranged between the carrier layer and the optical film, the damping layer having a plurality of apertures which are arranged in alignment with the light sources.

8. The lighting device according to claim 7, wherein a wall thickness of the damping layer is greater than a height of the light sources.

9. The lighting device according to claim 7, wherein the damping layer consists of a flexible material.

10. The lighting device according to claim 7, wherein the optical film is a first optical film and a second optical film is arranged between the first optical film and the damping layer, wherein the second optical film comprises raised bulges which have a different geometric shape than the bulges of the first optical film.

11. The lighting device according to claim 1, comprising a plurality of primary optical composites, including:
a first primary optical composite, wherein the optical film is a first optical film, and the first primary optical composite comprises the first optical film and a first decorative frame;
a second primary optical composite comprising a second optical film and a second decorative frame;
wherein the first and second primary optical composites each have differently shaped bulges;
wherein the first and second primary optical composites are arranged next to one another on the carrier layer covered with a damping layer;
wherein the first primary optical composite is arranged in a first section of the lighting device, the first section configured to be arranged in a vertical body area of the vehicle; and
wherein the second primary optical composite is arranged in a second section of the lighting device, the second section arranged at an angle of inclination to a vertical plane of the vertical body area.

12. The lighting device according to claim 1, wherein the optical film consists of a material such that a light beam striking the optical film perpendicularly is deflected by a predetermined angle of refraction.

13. A method of manufacturing the lighting device of claim 1, comprising:
providing a carrier layer on which a plurality of light sources are arranged in a matrix-like manner and an optical film;
forming a plurality of optical elements arranged in a matrix-like manner as raised bulges from a base surface of the optical film, wherein the bulges of the optical film are produced by thermal forming;
aligning a decorative frame with the optical film, the decorative frame comprising openings for receiving the bulges, such that the openings of the decorative frame surround the bulges; and
materially bonding the decorative frame to the optical film to form a primary optical composite.

14. The method according to claim 13, wherein a damping layer is placed on the carrier layer provided with the light sources, the damping layer having a plurality of apertures, wherein the light sources are arranged in the apertures of the damping layer, and in that the primary optical composite is then connected to the damping layer and the carrier layer in a force-fitting manner, with the base surface of the optical film abutting against the damping layer.

15. The method according to claim 14, wherein a plurality of primary optical composites, which have differently formed bulges, are placed on the damping layer in a butt-to-butt manner with their edges facing one another and are then connected to the damping layer and the carrier layer in a force-fitting manner.
